(19) United States
(12) Patent Application Publication
(10) Pub. No.: US 2026/0201079 A1
(43) Pub. Date: Jul. 16, 2026

(54) ETHYLENE / PROPYLENE RECYCLE THROUGH COPOLYMER POLYPROPYLENE GAS PHASE REACTOR SYSTEM INCREASING MONOMER EFFICIENCY

(71) Applicant: BRASKEM AMERICA, INC., Philadelpia, PA (US)

(72) Inventors: Robert T. Somich, Pittsburgh, PA (US); Daniela Kreusberg Molina, Sao Paulo (BR); Goutham Kottamreddy, Pittsburgh, PA (US); Nairalice Reis, Sao Paulo (BR)

(21) Appl. No.: 19/184,445

(22) Filed: Apr. 21, 2025

Related U.S. Application Data
(60) Provisional application No. 63/746,225, filed on Jan. 16, 2025.

(51) Int. Cl. C08F 2/01; C08F 110/02; C08F 110/06

(52) U.S. Cl. CPC C08F 2/01; C08F 110/02; C08F 110/06

(57) ABSTRACT

A first polymer reactor system can include a recovery system, a reclaimed first olefin stream, a volatile first olefin stream, where the reclaimed first olefin stream and the volatile first olefin stream are in entry-fluid communication with the recovery system.

### CROSS-REFERENCE TO RELATED APPLICATIONS

The present application claims the benefit of priority under 35 U.S.C. § 119(e) to U.S. Provisional Patent Application No. 63/746,225, filed on Jan. 16, 2025.

### BACKGROUND OF THE INVENTION

In many polyolefin production systems, monomer mass loss is an on-going problem. In the system and process for making polyolefin, monomer is fed into the system and converted to polymer. The system has, and the process uses, at least one olefin reactor. In an ideal system and process, the mass of total monomer fed into the system would be equal to the total mass of polymer produced by the system. However, in most systems and processes in practice, not all monomer is consumed, leading to monomer loss in output streams from the system. This monomer loss leads to a monetary loss, in that not all monomer is consumed and less polymer is produced.

It is an object of the present invention to design a system and process for making polyolefin that limits monomer loss.

### BRIEF SUMMARY OF THE INVENTION

An embodiment of the present invention relates to first polymer reactor system, comprising: a recovery system, a reclaimed first olefin stream (8), a volatile first olefin stream (10), wherein the reclaimed first olefin stream (8) and the volatile first olefin stream (10) are in entry-fluid communication with the recovery system.

Another embodiment of the present invention relates to any first polymer reactor system herein, the recovery system comprises a membrane, a sieve, a distillation column, or a combination thereof.

Another embodiment of the present invention relates to any first polymer reactor system herein, further comprising: a first olefin transfer stream (13), wherein the first olefin transfer stream (13) is in exit-fluid communication from the recovery system and entry-fluid communication with the first olefin reclamation apparatus.

Another embodiment of the present invention relates to any first polymer reactor system herein, further comprising: a first olefin feed stream (1), a first olefin feed tank, a first hydrogen feed stream (4), a first hydrogen feed source, a first catalyst feed stream (5), a first catalyst feed source, a first olefin reactor transfer feed (3), a first olefin reactor, configured to produce a first polymer, a first polymer transfer feed (6), a first polymer/first olefin separator, a first polymer/first olefin transfer feed (9), a first polymer/first olefin devolatilization apparatus, a first olefin reclamation apparatus, a steam source, a steam off-take stream (12), a reclaimed-first olefin stream (2), a first olefin-separated stream (7), an off-gas stream (14), a first polymer exit stream (11), and a first polymer product bin, wherein the first olefin feed stream (1) is in entry-fluid communication with the first olefin feed tank, wherein the reclaimed-first olefin stream (2) is in exit-fluid communication from the first olefin reclamation apparatus and entry-fluid communication with the first olefin feed tank, wherein the first olefin reactor transfer feed (3) is in exit-fluid communication with the first olefin feed tank and entry-fluid communication with the first olefin reactor, wherein the first polymer transfer feed (6) is in exit-fluid communication with the first olefin reactor and in entry-fluid communication with the first polymer/first olefin separator, wherein the first olefin-separated stream (7) is in exit-fluid communication with the first polymer/first olefin separator and in entry-fluid communication with the first olefin reclamation apparatus, wherein the first polymer transfer feed (9) is in exit-fluid communication with the first polymer/first olefin separator and in entry-fluid communication with the comonomer reactor, and wherein the first polymer exit stream (11) is in exit-fluid communication with the first polymer/first olefin devolatilization apparatus and in entry-fluid communication with the first polymer product bin.

Another embodiment of the present invention relates to any first polymer reactor system herein, wherein off-gas stream (14) comprises paraffin, preferably ethane and propane, and does not contain first olefin, preferably each of ethylene and propylene.

Another embodiment of the present invention relates to any first polymer reactor system herein, wherein the recovery system is in exit-fluid communication with at least the off-gas stream (14) and a steam off-take stream (12).

Another embodiment of the present invention relates to any first polymer reactor system herein, wherein the recovery system is in exit-fluid communication with only the off-gas stream (14) and a steam off-take stream (12).

Another embodiment of the present invention relates to any first polymer reactor system herein, wherein first olefin feed stream (1) comprises a C₂-C₁₀ olefin, a C₂-C₁₀ paraffin, or a combination thereof, preferably comprises ethane, propane, ethylene, and propylene.

Another embodiment of the present invention relates to any first polymer reactor system herein, wherein first olefin feed stream (1) comprises a C₂-C₁₀ olefin, a C₂-C₁₀ paraffin, or a combination thereof, preferably comprises ethane, propane, ethylene, and propylene, wherein the C₂-C₁₀ olefin is present in first olefin feed stream (1) in an amount of at least 90 wt %, relative to 100 wt % of a content of first olefin feed stream (1).

Another embodiment of the present invention relates to any first polymer reactor system herein, wherein the first olefin feed stream (1) comprises: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

Another embodiment of the present invention relates to any first polymer reactor system herein, wherein the first catalyst feed stream (5) comprises a Ziegler-Natta catalyst, a metallocene catalyst, or a combination thereof.

Another embodiment of the present invention relates to any first polymer reactor system herein, wherein the first olefin reactor comprises a gas-phase reactor, a slurry-loop reactor, or a combination thereof.

Another embodiment of the present invention relates to any first polymer reactor system herein, wherein first olefin-separated stream (7) comprises at least one of olefin and paraffin, preferably at least one of ethane, propane, ethylene, and propylene.

Another embodiment of the present invention relates to any first polymer reactor system herein, wherein first olefin-separated stream (7) comprises: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

Another embodiment of the present invention relates to any first polymer reactor system herein, wherein first olefin-separated stream (7) comprises a first olefin and paraffin, wherein the first olefin is present in first olefin-separated stream (7) in an amount of at least 95 wt %, relative to a total weight of the first olefin and paraffin.

Another embodiment of the present invention relates to any first polymer reactor system herein, wherein first olefin transfer stream (13) comprises first olefin, in an amount of at least 99.5 wt %, relative to a total weight of first olefin transfer stream (13).

Another embodiment of the present invention relates to any first polymer reactor system herein, wherein reclaimed-first olefin stream (2) comprises first olefin in an amount of at least 99.5 wt %, relative to a total weight of first olefin transfer stream (13).

Another embodiment of the present invention relates to any first polymer reactor system herein, wherein the first polymer comprises an ethylene homopolymer, a propylene homopolymer, a random copolymer comprising reacted units of ethylene and propylene, an impact copolymer, or a combination thereof.

Another embodiment of the present invention relates to any first polymer reactor system herein, wherein the first polymer comprises an ethylene homopolymer, a propylene homopolymer, a random copolymer comprising reacted units of ethylene and propylene, an impact copolymer, or a combination thereof, and wherein the first polymer comprises a number-average molecular weight of from 100 to 1,000,000 g/mol, wherein the first polymer comprises a weight-average molecular weight of from 1,000 to 2,000,000 g/mol, wherein the first polymer comprises a polydispersity index of from 1 to 20.

Another embodiment of the present invention relates to a copolymer reactor system, comprising: a recovery system, a reclaimed first olefin stream (8), a comonomer recirculating stream (17), a volatile comonomer stream (20), wherein the reclaimed first olefin stream (8), the comonomer recirculating stream (17), and the volatile comonomer stream (20), are in entry-fluid communication with the recovery system.

Another embodiment of the present invention relates to any copolymer reactor system herein, wherein the recovery system comprises a membrane, a sieve, a distillation column, or a combination thereof.

Another embodiment of the present invention relates to any copolymer reactor system herein, that can further comprise: a volatile comonomer off-gas stream (16), wherein the volatile comonomer off-gas stream (16) is in exit-fluid communication from the recovery system and entry-fluid communication with the first olefin reclamation apparatus.

Another embodiment of the present invention relates to any copolymer reactor system herein, wherein volatile comonomer off-gas stream (16) comprises first olefin, in an amount of at least 99.5 wt %, relative to a total weight of volatile comonomer off-gas stream (16).

Another embodiment of the present invention relates to any copolymer reactor system herein, that can further comprise: a first olefin feed stream (1), a first olefin feed tank, a first hydrogen feed stream (4), a first hydrogen feed source, a first catalyst feed stream (5), a first catalyst feed source, a first olefin reactor transfer feed (3), a first olefin reactor, configured to produce a first polymer, a first polymer transfer feed (6), a first polymer/first olefin separator, a first olefin-separated stream (7), a first olefin reclamation apparatus, a reclaimed-first olefin stream (2), a first polymer transfer feed (9), a comonomer reactor, configured to make a copolymer in the presence of the first polymer, to form a final polymer, a comonomer rich stream (13), a copolymer/comonomer transfer stream (14), a copolymer/comonomer separator, a volatile comonomer stream (15), a final polymer transfer stream (18), a final polymer devolatilization apparatus, a final polymer isolation stream (19), a final polymer product bin, an ethylene stripper, an ethylene rich stream (21), a second off-gas stream (22), a steam source, a second steam off-take stream (23), comonomer feeds (10, 11), a second hydrogen feed (12), wherein the first olefin feed stream (1) is in entry-fluid communication with the first olefin feed tank, wherein the first olefin reactor transfer feed (3) is in exit-fluid communication with the first olefin feed tank and entry-fluid communication with the first olefin reactor, wherein the first polymer transfer feed (6) is in exit-fluid communication with the first olefin reactor and in entry-fluid communication with the first polymer/first olefin separator, wherein the first polymer transfer feed (9) is in exit-fluid communication with the first polymer/first olefin separator and in entry-fluid communication with the comonomer reactor, wherein the copolymer/comonomer transfer stream (14) is in exit-fluid communication with the comonomer reactor and entry-fluid communication with the copolymer/comonomer separator, wherein the volatile comonomer stream (15) is in exit-fluid communication with the copolymer/comonomer separator and entry-fluid communication with the ethylene stripper, wherein the final polymer transfer stream (18) is in exit-fluid communication with the copolymer/comonomer separator and entry-fluid communication with the final polymer devolatilization apparatus, wherein the final polymer isolation stream (19) in exit-fluid communication with the final polymer devolatilization apparatus and entry-fluid communication with the final polymer product bin, wherein the ethylene rich stream (21) is in exit-fluid communication with the recovery system and entry-fluid communication with the ethylene stripper, wherein the reclaimed-first olefin stream (2) is in exit-fluid communication from the recovery system and entry-fluid communication with the first olefin feed tank, and wherein the comonomer rich stream (13) is in exit-fluid communication from the recovery system and entry-fluid communication with the first olefin reclamation apparatus.

Another embodiment of the present invention relates to any copolymer reactor system herein, wherein second off-gas stream (22) comprises paraffin, preferably ethane and propane, and does not contain first olefin, preferably each of ethylene and propylene.

Another embodiment of the present invention relates to any copolymer reactor system herein, wherein the recovery system is in exit-fluid communication with at least the second off-gas stream (22) and the second steam off-take stream (23).

Another embodiment of the present invention relates to any copolymer reactor system herein, wherein the recovery system is in exit-fluid communication with only the second off-gas stream (22) and the second steam off-take stream (23).

Another embodiment of the present invention relates to any copolymer reactor system herein, wherein first olefin feed stream (1) comprises a C₂-C₁₀ olefin, a C₂-C₁₀ paraffin, or a combination thereof, preferably comprises ethane, propane, ethylene, and propylene.

Another embodiment of the present invention relates to any copolymer reactor system herein, wherein first olefin feed stream (1) comprises a C₂-C₁₀ olefin, a C₂-C₁₀ paraffin, or a combination thereof, preferably comprises ethane, propane, ethylene, and propylene, wherein the C₂-C₁₀ olefin is present in first olefin feed stream (1) in an amount of at least 90 wt %, relative to 100 wt % of a content of first olefin feed stream (1).

Another embodiment of the present invention relates to any copolymer reactor system herein, wherein the first olefin feed stream (1) comprises: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

Another embodiment of the present invention relates to any copolymer reactor system herein, wherein the first catalyst feed stream (5) comprises a Ziegler-Natta catalyst, a metallocene catalyst, or a combination thereof.

Another embodiment of the present invention relates to any copolymer reactor system herein, wherein each of the first olefin reactor and the comonomer reactor comprises a gas-phase reactor, a slurry-loop reactor, or a combination thereof.

Another embodiment of the present invention relates to any copolymer reactor system herein, wherein first olefin-separated stream (7) comprises at least one of olefin and paraffin, preferably at least one of ethane, propane, ethylene, and propylene.

Another embodiment of the present invention relates to any copolymer reactor system herein, wherein first olefin-separated stream (7) comprises: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

Another embodiment of the present invention relates to any copolymer reactor system herein, wherein first olefin-separated stream (7) comprises a first olefin and paraffin, wherein the first olefin is present in first olefin-separated stream (7) in an amount of at least 95 wt %, relative to a total weight of the first olefin and paraffin.

Another embodiment of the present invention relates to any copolymer reactor system herein, wherein reclaimed-first olefin stream (2) comprises first olefin in an amount of at least 99.5 wt %, relative to a total weight of first olefin transfer stream (13).

Another embodiment of the present invention relates to any copolymer reactor system herein, wherein the first polymer comprises an ethylene homopolymer, a propylene homopolymer, a random copolymer comprising reacted units of ethylene and propylene, an impact copolymer, or a combination thereof.

Another embodiment of the present invention relates to any copolymer reactor system herein, wherein the first polymer comprises an ethylene homopolymer, a propylene homopolymer, a random copolymer comprising reacted units of ethylene and propylene, an impact copolymer, or a combination thereof, and wherein the first polymer comprises a number-average molecular weight of from 100 to 1,000,000 g/mol, wherein the first polymer comprises a weight-average molecular weight of from 1,000 to 2,000,000 g/mol, wherein the first polymer comprises a polydispersity index of from 1 to 20.

### BRIEF DESCRIPTION OF THE DRAWINGS

FIG. 1 shows an olefin reactor system for making homopolymer or random copolymer, and process of making the homopolymer or random copolymer, with a recovery system.

FIG. 2 shows an olefin reactor system for making a polyolefin, and a process of making the polyolefin, with a recovery system.

FIG. 3 shows an olefin reactor system for making a polyolefin, and a process of making the polyolefin, without a recovery system.

### DETAILED DESCRIPTION OF THE INVENTION

The indefinite articles “a” and “an” generally mean “at least one” in the sense of “a” or “an”. Those skilled in the art will understand that the indefinite article “a” does not necessarily mean the indefinite article “a” but rather the indefinite article “a” in the sense of “1”, and that in one embodiment the indefinite article “a” also includes the indefinite article “a” (1). For example, as used herein, the phrase “a gas-phase reactor” can mean one gas-phase reactor or at least two gas-phase reactors.

As used herein, unless indicated otherwise, the term “propane” can refer to any three carbon saturated hydrocarbon, such as, for example propane and isopropane.

As used herein, unless indicated otherwise, the term “butane” can refer to any four carbon saturated hydrocarbon, such as, for example, butane and isobutane.

As used herein, unless indicated otherwise, the term “pentane” can refer to any five carbon saturated hydrocarbon, such as, for example, pentane, isopentane, and neopentane.

As used herein, unless indicated otherwise, the term “hexane” can refer to any six carbon saturated hydrocarbon, such as, for example, hexane, 2-methylpentane, 3-methylpentane, 2,3-dimethylbutane, and 2,2-dimethylbutane.

As used herein, unless indicated otherwise, “ethene” and “ethylene” are synonymous with each other. Likewise, “propene” and “propylene” are synonymous with each other.

As used herein, unless indicated otherwise, the term “propylene” can refer to any three carbon, double bond comprising, monomer thereof, such as, for example, α-propylene and isopropylene.

As used herein, unless indicated otherwise, the term “butene” can refer to any four carbon, double bond comprising, monomer thereof, such as, for example, «-butene, cis-2-butene, trans-2-butene, and isobutene.

As used herein, unless indicated otherwise, the term “pentene” can refer to any five carbon, double bond comprising, monomer thereof, such as, for example, 1-pentene, cis-2-pentene, trans-2-pentene, 2-methylbut-1-ene, and 3-methylbut-1-ene.

As used herein, unless indicated otherwise, the term “hexene” can refer to any six carbon, double bond comprising, monomer thereof, such as, for example, hex-1-ene, hex-2-ene (E/Z), hex-3-ene (E/Z), 2-methylpent-1-ene, 3-methylpent-1-ene (R/S), 4-methylpent-1-ene, 2-methylpent-2-ene, 3-methylpent-2-ene (E/Z), 4-methylpent-2-ene (E/Z), 2,3-dimethylbut-1-ene, 3,3-dimethylbut-1-ene, 2-ethylbut-1-ene, 2,3-dimethylbut-2-ene.

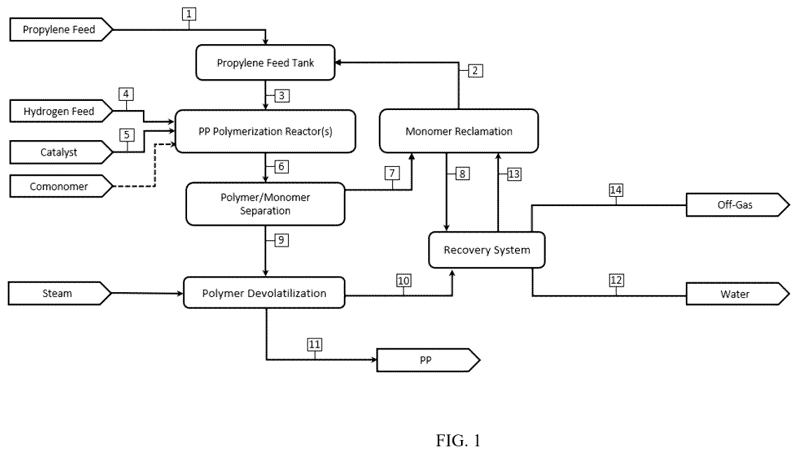

As used herein, various streams and aspects of the reactor system have numerical identifiers, for example “a first olefin feed stream (1).” Unless otherwise indicated, a recitation of such a stream can refer to the embodiments seen in any figure of this application. Thus, for example, “a first olefin feed stream (1)” could refer to the stream (1) in any of FIGS. 1, 2, and 3.

As used herein, a term “entry-fluid communication” can describe a direction of fluid flow in streams identified herein, between different and various units of reactor systems. For example, a fluid can leave one unit in a reactor system herein, such as a feed tank, and enter into another unit in a reactor system, such as a polymerization reactor. Thus, fluid flow from a propylene feed tank to a PP polymerization reactor, which can be seen in FIG. 1, would be propylene entering the PP polymerization reactor and would be in “entry-fluid communication” with the PP polymerization reactor.

As used herein, a term, “exit-fluid communication” can also describe a direction of fluid flow in streams identified herein, between different and various units of reactor systems.

For example, a fluid can leave from, or exit out of, a unit in a reactor system herein, such as a feed tank, and enter into another unit in a reactor system, such as a polymerization reactor. Thus, fluid flow from a propylene feed tank to a PP polymerization reactor, which can be seen in FIG. 1, would be propylene leaving or exiting the propylene feed tank and would thus be in “exit-fluid communication” with the feed tank.

### First Polymer Reactor System

An embodiment of the present invention relates to first polymer reactor system, comprising: a recovery system, a reclaimed first olefin stream (8), a volatile first olefin stream (10), wherein the reclaimed first olefin stream (8) and the volatile first olefin stream (10) are in entry-fluid communication with the recovery system.

The recovery system can comprise a membrane, a sieve, a distillation column, or a combination thereof. Any membrane that can separate olefins and paraffins, is suitable for use in the present reactor system. Suitable membranes, sieves, and distillation columns, are discussed in Olefin/Paraffin Separation Technology: A Review, Ind. Eng. Chem. Res. 1993, 32, 2208-2212.

The recovery system can be integrated into a first polymer reactor system herein, using any suitable connectors and can be operated at any suitable reaction parameters at bench, pilot, or industrial scale.

Any first polymer reactor system herein can further comprise: a first olefin transfer stream (13), wherein the first olefin transfer stream (13) is in exit-fluid communication from the recovery system and entry-fluid communication with the first olefin reclamation apparatus.

Any first polymer reactor system herein, can further comprise: a first olefin feed stream (1), a first olefin feed tank, a first hydrogen feed stream (4), a first hydrogen feed source, a first catalyst feed stream (5), a first catalyst feed source, a first olefin reactor transfer feed (3), a first olefin reactor, configured to produce a first polymer, a first polymer transfer feed (6), a first polymer/first olefin separator, a first polymer/first olefin transfer feed (9), a first polymer/first olefin devolatilization apparatus, a first olefin reclamation apparatus, a steam source, a steam off-take stream (12), a reclaimed-first olefin stream (2), a first olefin-separated stream (7), an off-gas stream (14), a first polymer exit stream (11), and a first polymer product bin, wherein the first olefin feed stream (1) is in entry-fluid communication with the first olefin feed tank, wherein the reclaimed-first olefin stream (2) is in exit-fluid communication from the first olefin reclamation apparatus and entry-fluid communication with the first olefin feed tank, wherein the first olefin reactor transfer feed (3) is in exit-fluid communication with the first olefin feed tank and entry-fluid communication with the first olefin reactor, wherein the first polymer transfer feed (6) is in exit-fluid communication with the first olefin reactor and in entry-fluid communication with the first polymer/first olefin separator, wherein the first olefin-separated stream (7) is in exit-fluid communication with the first polymer/first olefin separator and in entry-fluid communication with the first olefin reclamation apparatus, wherein the first polymer transfer feed (9) is in exit-fluid communication with the first polymer/first olefin separator and in entry-fluid communication with the comonomer reactor, and wherein the first polymer exit stream (11) is in exit-fluid communication with the first polymer/first olefin devolatilization apparatus and in entry-fluid communication with the first polymer product bin.

In any first polymer reactor system herein, first olefin can comprise any of ethylene, propylene, and any other olefin of four to twelve carbon atoms.

In any first polymer reactor system herein, off-gas stream (14) comprises paraffin, preferably ethane and propane, and does not contain first olefin, preferably each of ethylene and propylene.

In any first polymer reactor system herein, the recovery system is in exit-fluid communication with at least the off-gas stream (14) and a steam off-take stream (12). Preferably, in any first polymer reactor system herein, the recovery system is in exit-fluid communication with only the off-gas stream (14) and a steam off-take stream (12).

In any first polymer reactor system herein, first olefin feed stream (1) comprises a C₂-C₁₀ olefin, a C₂-C₁₀ paraffin, or a combination thereof, preferably comprises ethane, propane, ethylene, and propylene.

In any first polymer reactor system herein, first olefin feed stream (1) comprises a C₂-C₁₀ olefin, a C₂-C₁₀ paraffin, or a combination thereof, preferably comprises ethane, propane, ethylene, and propylene, where the C₂-C₁₀ olefin is present in first olefin feed stream (1) in an amount of at least 90 wt %, relative to 100 wt % of a content of first olefin feed stream (1).

In any first polymer reactor system herein, the first olefin feed stream (1) comprises: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

In any first polymer reactor system herein, the first catalyst feed stream (5) comprises a Ziegler-Natta catalyst, a metallocene catalyst, or a combination thereof. Any Ziegler-Natta or metallocene catalyst useful for polyolefin production, can be used in the present invention.

In any first polymer reactor system herein, the first olefin reactor comprises a gas-phase reactor, a slurry-loop reactor, or a combination thereof. Such reactors could be those of SPHERIENE, SPHERIPOL, and UNIPOL.

In any first polymer reactor system herein, first olefin-separated stream (7) can comprise at least one of olefin and paraffin, preferably at least one of ethane, propane, ethylene, and propylene.

In any first polymer reactor system herein, first olefin-separated stream (7) can comprise: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

In any first polymer reactor system herein, first olefin-separated stream (7) comprises a first olefin and paraffin, wherein the first olefin is present in first olefin-separated stream (7) in an amount of at least 95 wt %, relative to a total weight of the first olefin and paraffin.

In any first polymer reactor system herein, first olefin transfer stream (13) comprises first olefin, in an amount of at least 99.5 wt %, relative to a total weight of first olefin transfer stream (13).

In any first polymer reactor system herein, reclaimed-first olefin stream (2) comprises first olefin in an amount of at least 99.5 wt %, relative to a total weight of first olefin transfer stream (13).

In any first polymer reactor system herein, the first polymer can comprise an ethylene homopolymer, a propylene homopolymer, a random copolymer comprising reacted units of ethylene and propylene, an impact copolymer, or a combination thereof.

The first polymer can comprise an ethylene homopolymer, a propylene homopolymer, a random copolymer comprising reacted units of ethylene and propylene, an impact copolymer, or a combination thereof, and wherein the first polymer comprises a number-average molecular weight of from 100 to 1,000,000 g/mol, wherein the first polymer comprises a weight-average molecular weight of from 1,000 to 2,000,000 g/mol, wherein the first polymer comprises a polydispersity index of from 1 to 20.

### Copolymer Reactor System

Another embodiment of the present invention relates to a copolymer reactor system, that can comprise: a recovery system, a reclaimed first olefin stream (8), a comonomer recirculating stream (17), a volatile comonomer stream (20), wherein the reclaimed first olefin stream (8), the comonomer recirculating stream (17), and the volatile comonomer stream (20), are in entry-fluid communication with the recovery system.

In any copolymer reactor system herein, the recovery system comprises a membrane, a sieve, a distillation column, or a combination thereof. The recovery system from the First Polymer Reactor System can be used in any copolymer reactor systems embodiment.

Any copolymer reactor system herein, can further comprise: a volatile comonomer off-gas stream (16), wherein the volatile comonomer off-gas stream (16) is in exit-fluid communication from the recovery system and entry-fluid communication with the first olefin reclamation apparatus.

In any copolymer reactor system herein, wherein volatile comonomer off-gas stream (16) comprises first olefin, in an amount of at least 99.5 wt %, relative to a total weight of volatile comonomer off-gas stream (16).

Any copolymer reactor system herein, can further comprise: a first olefin feed stream (1), a first olefin feed tank, a first hydrogen feed stream (4), a first hydrogen feed source, a first catalyst feed stream (5), a first catalyst feed source, a first olefin reactor transfer feed (3), a first olefin reactor, configured to produce a first polymer, a first polymer transfer feed (6), a first polymer/first olefin separator, a first olefin-separated stream (7), a first olefin reclamation apparatus, a reclaimed-first olefin stream (2), a first polymer transfer feed (9), a comonomer reactor, configured to make a copolymer in the presence of the first polymer, to form a final polymer, a comonomer rich stream (13), a copolymer/comonomer transfer stream (14), a copolymer/comonomer separator, a volatile comonomer stream (15), a final polymer transfer stream (18), a final polymer devolatilization apparatus, a final polymer isolation stream (19), a final polymer product bin, an ethylene stripper, an ethylene rich stream (21), a second off-gas stream (22), a steam source, a second steam off-take stream (23), comonomer feeds (10, 11), a second hydrogen feed (12), wherein the first olefin feed stream (1) is in entry-fluid communication with the first olefin feed tank, wherein the first olefin reactor transfer feed (3) is in exit-fluid communication with the first olefin feed tank and entry-fluid communication with the first olefin reactor, wherein the first polymer transfer feed (6) is in exit-fluid communication with the first olefin reactor and in entry-fluid communication with the first polymer/first olefin separator, wherein the first polymer transfer feed (9) is in exit-fluid communication with the first polymer/first olefin separator and in entry-fluid communication with the comonomer reactor, wherein the copolymer/comonomer transfer stream (14) is in exit-fluid communication with the comonomer reactor and entry-fluid communication with the copolymer/comonomer separator, wherein the volatile comonomer stream (15) is in exit-fluid communication with the copolymer/comonomer separator and entry-fluid communication with the ethylene stripper, wherein the final polymer transfer stream (18) is in exit-fluid communication with the copolymer/comonomer separator and entry-fluid communication with the final polymer devolatilization apparatus, wherein the final polymer isolation stream (19) in exit-fluid communication with the final polymer devolatilization apparatus and entry-fluid communication with the final polymer product bin, wherein the ethylene rich stream (21) is in exit-fluid communication with the recovery system and entry-fluid communication with the ethylene stripper, wherein the reclaimed-first olefin stream (2) is in exit-fluid communication from the recovery system and entry-fluid communication with the first olefin feed tank, and wherein the comonomer rich stream (13) is in exit-fluid communication from the recovery system and entry-fluid communication with the first olefin reclamation apparatus.

In any copolymer reactor system herein, second off-gas stream (22) can comprise paraffin, preferably ethane and propane, and does not contain first olefin, preferably each of ethylene and propylene.

In any copolymer reactor system herein, the recovery system is in exit-fluid communication with at least the second off-gas stream (22) and the second steam off-take stream (23).

In any copolymer reactor system herein, wherein the recovery system is in exit-fluid communication with only the second off-gas stream (22) and the second steam off-take stream (23).

In any copolymer reactor system herein, first olefin feed stream (1) comprises a C₂-C₁₀ olefin, a C₂-C₁₀ paraffin, or a combination thereof, preferably comprises ethane, propane, ethylene, and propylene.

In any copolymer reactor system herein, first olefin feed stream (1) comprises a C₂-C₁₀ olefin, a C₂-C₁₀ paraffin, or a combination thereof, preferably comprises ethane, propane, ethylene, and propylene, wherein the C₂-C₁₀ olefin is present in first olefin feed stream (1) in an amount of at least 90 wt %, relative to 100 wt % of a content of first olefin feed stream (1).

In any copolymer reactor system herein, the first olefin feed stream (1) comprises: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

In any copolymer reactor system herein, the first catalyst feed stream (5) comprises a Ziegler-Natta catalyst, a metallocene catalyst, or a combination thereof.

In any copolymer reactor system herein, each of the first olefin reactor and the comonomer reactor comprises a gas-phase reactor, a slurry-loop reactor, or a combination thereof.

In any copolymer reactor system herein, first olefin-separated stream (7) comprises at least one of olefin and paraffin, preferably at least one of ethane, propane, ethylene, and propylene.

In any copolymer reactor system herein, first olefin-separated stream (7) comprises: a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, 3-hexene; a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane; or a combination thereof.

In any copolymer reactor system herein, first olefin-separated stream (7) comprises a first olefin and paraffin, wherein the first olefin is present in first olefin-separated stream (7) in an amount of at least 95 wt %, relative to a total weight of the first olefin and paraffin.

In any copolymer reactor system herein, reclaimed-first olefin stream (2) comprises first olefin in an amount of at least 99.5 wt %, relative to a total weight of first olefin transfer stream (13).

In any copolymer reactor system herein, the first polymer comprises an ethylene homopolymer, a propylene homopolymer, a random copolymer comprising reacted units of ethylene and propylene, an impact copolymer, or a combination thereof.

In any copolymer reactor system herein, the first polymer comprises an ethylene homopolymer, a propylene homopolymer, a random copolymer comprising reacted units of ethylene and propylene, an impact copolymer, or a combination thereof, and wherein the first polymer comprises a number-average molecular weight of from 100 to 1,000,000 g/mol, wherein the first polymer comprises a weight-average molecular weight of from 1,000 to 2,000,000 g/mol, wherein the first polymer comprises a polydispersity index of from 1 to 20.

### EXAMPLES

### Reactor for a First Polymer

A first polymer reactor system having a single slurry-loop reactor, was modelled for or with computational fluid flow dynamics. This reactor complex can be seen in FIG. 1, which can show a first polymer reactor system comprising a recovery system. In the modelled reactor system, propylene was reacted in the loop-slurry reactor to produce a first polymer. Flow rates of propane, propylene, H₂, and H₂0, in streams identified in FIG. 1., are reported in Table 1. The modelled reactor system indicates stream 13 comprising propane and propylene, but is also a propylene-rich stream where propylene is present in an amount roughly ten times that of propane. Accordingly, the recovery system in this reactor system, is seen as recovering propylene from a would-be off-gas stream, and recycling propylene that would be lost in the would-be off-gas stream back into the propylene reactor.

TABLE 1
Homopolymer

| Stream | 2 | 7 | 8 | 13 | 10 |
|---|---|---|---|---|---|
| Propane | 4815.92 | 4839.25 | 83.06 | 59.73 | 116.03 |
| Propylene | 17225.74 | 16895.97 | 290.01 | 619.77 | 362.39 |
| Ethane | 0.00 | 0.00 | 0.00 | 0.00 | 0.00 |
| Ethylene | 0.00 | 0.00 | 0.00 | 0.00 | 0.00 |
| H₂ | 0.09 | 0.92 | 0.83 | 0.00 | 0.44 |
| H₂0 | 0.00 | 0.00 | 0.00 | 0.00 | |
| Total | 21362.24 | 21736.14 | 373.90 | 679.50 | 478.86 |
| C₂/C₃ | 0 | 0 | 0 | 0 | 0 |

### Reactor for a First and Second Polymer

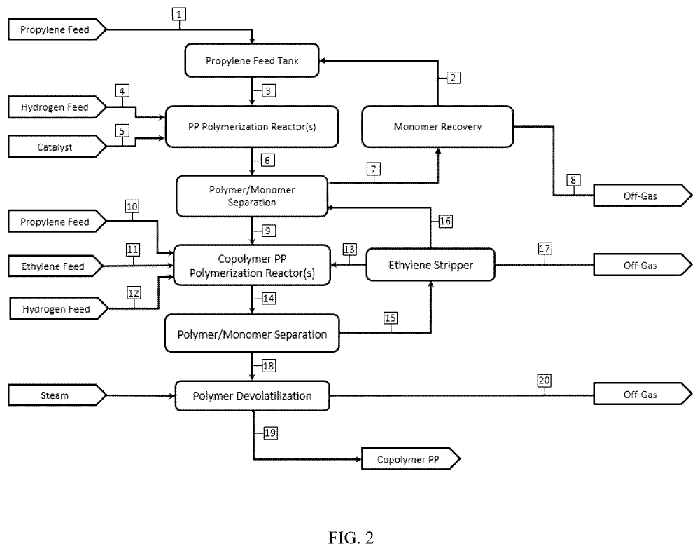

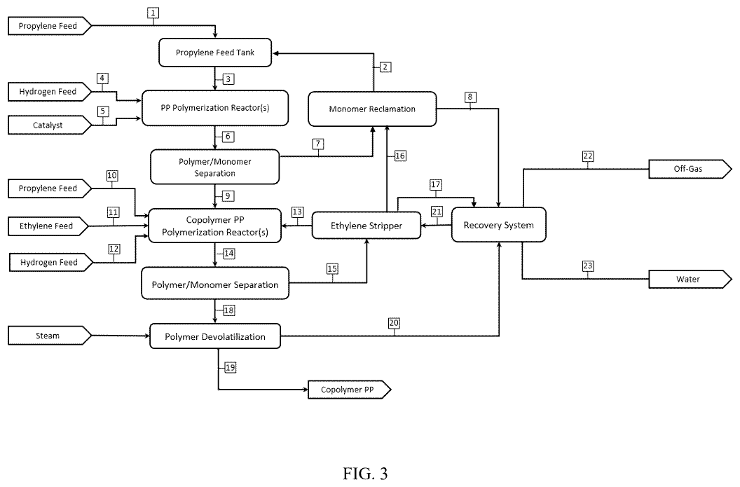

A reactor complex having a dual reactor system, was modelled for or with computational fluid flow dynamics, where a first reactor was a loop-slurry reactor and the second reactor was a gas-phase reactor. In a first modelled reactor system, no recovery system was present, corresponding to a reactor complex represented by FIG. 2. In a second modelled reactor, a recovery system was present, corresponding to a reactor complex represented by FIG. 3.

In each modelled dual reactor system, propylene was reacted in the loop-slurry reactor to produce a first polymer, and a combination of ethylene and propylene were reacted in the gas-phase reactor, in the presence of the first polymer, to produce a second polymer. The mixture of first and second polymers form an impact copolymer.

Streams for the exemplary dual reactor system without a recovery system are identified in the following Table 2, corresponding to those in FIG. 2. Table 2 reports the mass flow rates for specific streams in the FIG. 2 modelled dual reactor system. As seen in this table, stream 17, an off-gas stream, is rich in both propylene and ethylene, meaning that a substantial amount of unreacted monomers is present in the off-gas stream and not recycled back into the reactor system and reacted to form polymer.

TABLE 2

| Mass flow (kg/h) | | | | | | |
|---|---|---|---|---|---|---|
| Stream | | | | | | |
| 1 | 10 | 11 | 8 | 17 | 20 | 22 |

No Recovery System - FIG. 2

| | | | | | | | |
|---|---|---|---|---|---|---|---|
| Propylene | 25720.5 | 2481.61 | — | 85.73 | 362.32 | 1.57 | — |
| Ethylene | — | — | 4315.58 | — | 167.78 | 4.79 | — |

Streams for the exemplary dual reactor system without a recovery system are identified in the following Table 3, corresponding to those in FIG. 3. Table 3 reports the mass flow rates for specific streams in the FIG. 3 modelled dual reactor system. This modelled reactor system, like the one of FIG. 2, also has a stream 17, but this stream is sent from an ethylene stripper into a recovery system and is not vented in an off-gas stream, as in the system of FIG. 2. Further, the modelled dual reactor stream of FIG. 3 has a stream 21, not present in the system of FIG. 2.

Stream 17 in FIG. 3 exists an ethylene stripper and goes into a recovery system, and a stream 21 exists the recovery system and goes back to the ethylene stripper. This cycle shows a recovery and recycling of both ethylene and propylene in the reactor system of FIG. 3 that is not present in FIG. 2. Thus, the recovery system is shown to be useful in recycling some unreacted ethylene and propylene back into the reactor, to make polymer, rather than venting or burning some unreacted ethylene and propylene in an off-gas stream.

TABLE 3
Copolymer

| Stream | 2 | 7 | 8 | 13 | 15 | 16 | 17 | 20 | 21 |
|---|---|---|---|---|---|---|---|---|---|
| Propane | 4797.95 | 4839.25 | 83.06 | 41.39 | 489.69 | 41.77 | 0.38 | 116.03 | 59.84 |
| Propylene | 16932.36 | 16895.97 | 290.01 | 323.43 | 1529.39 | 326.40 | 2.97 | 362.39 | 622.59 |
| Ethane | 19.30 | 0.00 | 0.00 | 19.13 | 18.84 | 19.30 | 0.18 | 4.46 | 0.46 |
| Ethylene | 875.18 | 0.00 | 0.00 | 867.23 | 708.21 | 875.18 | 7.95 | 167.81 | 166.97 |
| H₂ | 2.10 | 0.92 | 0.83 | 1.99 | 1.87 | 2.01 | 0.02 | 0.44 | 0.14 |
| H₂0 | 0.00 | 0.00 | 0.00 | 0.00 | 0.00 | 0.00 | 0.00 | 0.00 | 0.00 |
| Total | 22626.89 | 21736.14 | 373.90 | 1253.16 | 2747.99 | 1264.65 | 11.49 | 651.13 | 850.01 |
| C₂/C₃ | 0.05 | 0.00 | 0.00 | 2.68 | 0.46 | 2.68 | 2.68 | 0.46 | 0.27 |

The mass loss of monomer for the two modelled dual reactor systems was calculated and reported in Table 4.

TABLE 4
Mass loss of monomer from process

| Mass flow (kg/h) | No Recovery System | With Recovery System |
|---|---|---|
| Propylene | 449.62 | 32.77 |
| Ethylene | 172.65 | 8.79 |

For the modelled dual reactor system corresponding to FIG. 2, the mass loss of propylene and ethylene, was calculated to be 449.62 and 172.65 kilograms, respectively. When the recovery system was included, as is the case for modelled dual reactor system corresponding to FIG. 3, the calculated mass loss of propylene and ethylene dropped to 32.77 and 8.79 kilograms, respectively. These values correspond to a mass loss improvement, for propylene, of 172.83% and, for ethylene, of 180.62%.

1. A first polymer reactor system, comprising:
a recovery system,
a reclaimed first olefin stream (8),
a volatile first olefin stream (10),
wherein the reclaimed first olefin stream (8) and the volatile first olefin stream (10) are in entry-fluid communication with the recovery system.

2. The first polymer reactor system according to claim 1, wherein the recovery system comprises a membrane, a sieve, a distillation column, or a combination thereof.

3. The first polymer reactor system according to claim 1, further comprising:
a first olefin transfer stream (13),
wherein the first olefin transfer stream (13) is in exit-fluid communication from the recovery system and entry-fluid communication with the first olefin reclamation apparatus.

4. The first polymer reactor system according to claim 3, further comprising:
a first olefin feed stream (1),
a first olefin feed tank,
a first hydrogen feed stream (4),
a first hydrogen feed source,
a first catalyst feed stream (5),
a first catalyst feed source,
a first olefin reactor transfer feed (3),
a first olefin reactor, configured to produce a first polymer,
a first polymer transfer feed (6),
a first polymer/first olefin separator,
a first polymer/first olefin transfer feed (9)
a first polymer/first olefin devolatilization apparatus,
a first olefin reclamation apparatus,
a steam source,
a steam off-take stream (12),
a reclaimed-first olefin stream (2),
a first olefin-separated stream (7),
an off-gas stream (14),
a first polymer exit stream (11), and
a first polymer product bin,
wherein the first olefin feed stream (1) is in entry-fluid communication with the first olefin feed tank,
wherein the reclaimed-first olefin stream (2) is in exit-fluid communication from the first olefin reclamation apparatus and entry-fluid communication with the first olefin feed tank,
wherein the first olefin reactor transfer feed (3) is in exit-fluid communication with the first olefin feed tank and entry-fluid communication with the first olefin reactor,
wherein the first polymer transfer feed (6) is in exit-fluid communication with the first olefin reactor and in entry-fluid communication with the first polymer/first olefin separator,
wherein the first olefin-separated stream (7) is in exit-fluid communication with the first polymer/first olefin separator and in entry-fluid communication with the first olefin reclamation apparatus,
wherein the first polymer/first olefin transfer feed (9) is in exit-fluid communication with the first polymer/first olefin separator and in entry-fluid communication with the first polymer/first olefin devolatilization apparatus, and
wherein the first polymer exit stream (11) is in exit-fluid communication with the first polymer/first olefin devolatilization apparatus and in entry-fluid communication with the first polymer product bin.

5. The first polymer reactor system according to claim 4, wherein off-gas stream (14) comprises a paraffin and does not contain a first olefin.

6. The first polymer reactor system according to claim 4, wherein the recovery system is in exit-fluid communication with at least the off-gas stream (14) and the steam off-take stream (12).

7. The first polymer reactor system according to claim 4, wherein the recovery system is in exit-fluid communication with only the off-gas stream (14) and the steam off-take stream (12).

8. The first polymer reactor system according to claim 4, wherein first olefin feed stream (1) comprises a C₂-C₁₀ olefin, a C₂-C₁₀ paraffin, or a combination thereof.

9. The first polymer reactor system according to claim 4, wherein first olefin feed stream (1) comprises a C₂-C₁₀ olefin, a C₂-C₁₀ paraffin, or a combination thereof,
wherein the C₂-C₁₀ olefin and/or C₂-C₁₀ paraffin is present in the first olefin feed stream (1) in an amount of at least 90 wt %, relative to 100 wt % of a content of first olefin feed stream (1).

10. The first polymer reactor system according to claim 4, wherein the first olefin feed stream (1) comprises:
a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, and 3-hexene;
a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane;
or a combination thereof.

11. The first polymer reactor system according to claim 4, wherein the first catalyst feed stream (5) comprises a Ziegler-Natta catalyst, a metallocene catalyst, or a combination thereof.

12. The first polymer reactor system according to claim 4, wherein the first olefin reactor comprises a gas-phase reactor, a slurry-loop reactor, or a combination thereof.

13. The first polymer reactor system according to claim 4, wherein first olefin-separated stream (7) comprises an at least one of olefin and/or a paraffin.

14. The first polymer reactor system according to claim 4, wherein first olefin-separated stream (7) comprises:
a C₂-C₁₀ olefin comprising at least one olefin selected from the group consisting of ethylene, propylene, isopropylene, 1-butene, 2-butene, 1-pentene, 2-pentene, neo-pentene, 1-hexene, 2-hexene, and 3-hexene;
a C₂-C₁₀ paraffin comprising at least one paraffin selected from the group consisting of ethane, propane, isopropane, butane, pentane, isopentane, neo-pentane, hexane, 2-methylpentane, 3-methylpentane, 2,3-dimethylbutane, and neohexane;
or a combination thereof.

15. The first polymer reactor system according to claim 4, wherein first olefin-separated stream (7) comprises the first olefin and a paraffin, wherein the first olefin is present in first olefin-separated stream (7) in an amount of at least 95 wt %, relative to a total weight of the first olefin and paraffin.

16. The first polymer reactor system according to claim 4, wherein first olefin transfer stream (13) comprises the first olefin, in an amount of at least 99.5 wt %, relative to a total weight of first olefin transfer stream (13).

17. The first polymer reactor system according to claim 4, wherein reclaimed-first olefin stream (2) comprises the first olefin in an amount of at least 99.5 wt %, relative to a total weight of first olefin transfer stream (13).

18. The first polymer reactor system according to claim 4, wherein the first polymer comprises an ethylene homopolymer, a propylene homopolymer, a random copolymer comprising reacted units of ethylene and propylene, an impact copolymer, or a combination thereof.

19. The first polymer reactor system according to claim 4, wherein the first polymer comprises an ethylene homopolymer, a propylene homopolymer, a random copolymer comprising reacted units of ethylene and propylene, an impact copolymer, or a combination thereof, and
wherein the first polymer comprises a number-average molecular weight of from 100 to 1,000,000 g/mol,
wherein the first polymer comprises a weight-average molecular weight of from 1,000 to 2,000,000 g/mol, and
wherein the first polymer comprises a polydispersity index of from 1 to 20.

20. A copolymer reactor system, comprising:
a recovery system,
a reclaimed first olefin stream (8),
a comonomer recirculating stream (17),
a volatile comonomer stream (20),
wherein the reclaimed first olefin stream (8), the comonomer recirculating stream (17), and the volatile comonomer stream (20), are in entry-fluid communication with the recovery system.

21. The copolymer reactor system according to claim 20, wherein the recovery system comprises a membrane, a sieve, a distillation column, or a combination thereof.

22. The copolymer reactor system according to claim 20, further comprising:
a volatile comonomer off-gas stream (16), and
an ethylene stripper
wherein the volatile comonomer off-gas stream (16) is in exit-fluid communication from the ethylene stripper and entry-fluid communication with the first olefin reclamation apparatus.

23. The copolymer reactor system according to claim 22, wherein volatile comonomer off-gas stream (16) comprises a first olefin, in an amount of at least 99.5 wt %, relative to a total weight of volatile comonomer off-gas stream (16).

24. The copolymer reactor system according to claim 20, further comprising:
a first olefin feed stream (1),
a first olefin feed tank,
a first hydrogen feed stream (4),
a first hydrogen feed source,
a first catalyst feed stream (5),
a first catalyst feed source,
a first olefin reactor transfer feed (3),
a first olefin reactor, configured to produce a first polymer,
a first polymer transfer feed (6),
a first polymer/first olefin separator,
a first olefin-separated stream (7),
a first olefin reclamation apparatus,
a reclaimed-first olefin stream (2),
a first polymer transfer feed (9),
a comonomer reactor, configured to make a copolymer in the presence of the first polymer, to form a final polymer,
a comonomer rich stream (13),
a copolymer/comonomer transfer stream (14),
a copolymer/comonomer separator,
a volatile comonomer stream (15),
a final polymer transfer stream (18),
a final polymer devolatilization apparatus,
a final polymer isolation stream (19),
a final polymer product bin,
an ethylene stripper,
an ethylene rich stream (21),
a second off-gas stream (22)
a steam source,
a second steam off-take stream (23),
comonomer feeds (10, 11),
a second hydrogen feed (12),
wherein the first olefin feed stream (1) is in entry-fluid communication with the first olefin feed tank,
wherein the first olefin reactor transfer feed (3) is in exit-fluid communication with the first olefin feed tank and entry-fluid communication with the first olefin reactor,
wherein the first polymer transfer feed (6) is in exit-fluid communication with the first olefin reactor and in entry-fluid communication with the first polymer/first olefin separator,
wherein the first polymer transfer feed (9) is in exit-fluid communication with the first polymer/first olefin separator and in entry-fluid communication with the comonomer reactor,
wherein the copolymer/comonomer transfer stream (14) is in exit-fluid communication with the comonomer reactor and entry-fluid communication with the copolymer/comonomer separator,
wherein the volatile comonomer stream (15) is in exit-fluid communication with the copolymer/comonomer separator and entry-fluid communication with the ethylene stripper
wherein the final polymer transfer stream (18) is in exit-fluid communication with the copolymer/comonomer separator and entry-fluid communication with the final polymer devolatilization apparatus,
wherein the final polymer isolation stream (19) in exit-fluid communication with the final polymer devolatilization apparatus and entry-fluid communication with the final polymer product bin,
wherein the ethylene rich stream (21) is in exit-fluid communication with the recovery system and entry-fluid communication with the ethylene stripper,
wherein the reclaimed-first olefin stream (2) is in exit-fluid communication from the first olefin reclamation apparatus and entry-fluid communication with the first olefin feed tank, and
wherein the comonomer rich stream (13) is in exit-fluid communication from the ethylene stripper and entry-fluid communication with the comonomer reactor.

25. The copolymer reactor system according to claim 24, wherein second off-gas stream (22) comprises a paraffin and does not contain the first olefin.

26. The copolymer reactor system according to claim 24, wherein the recovery system is in exit-fluid communication with at least the second off-gas stream (22) and the second steam off-take stream (23).

27. The copolymer reactor system according to claim 24, wherein the recovery system is in exit-fluid communication with only the second off-gas stream (22) and the second steam off-take stream (23).

28-38. (canceled)
